(19) United States
(12) Patent Application Publication
(10) Pub. No.: US 2023/0106541 A1
(43) Pub. Date: Apr. 6, 2023

(54) FLUID-EJECTION ELEMENT HAVING ABOVE-CHAMBER LAYER THROUGH WHICH FLUID IS TO RECIRCULATE

(71) Applicant: Hewlett-Packard Development Company, L.P., Spring, TX (US)

(72) Inventor: Jacob Lum, Corvallis, OR (US)

(73) Assignee: Hewlett-Packard Development Company, L.P., Spring, TX (US)

(21) Appl. No.: 17/798,905

(22) PCT Filed: Mar. 5, 2020
(86) PCT No.: PCT/US2020/021175

§ 371 Date: Aug. 11, 2022

(51) Int. Cl. B41J 2/18

(52) U.S. Cl. CPC B41J 2/18; B41J 2202/12

(57) ABSTRACT

A fluid-ejection element of a fluid-ejection device includes a chamber layer having a chamber. The fluid-ejection element includes an above-chamber layer fluidically connected to the chamber layer and through which fluid is to recirculate. The fluid-ejection element includes a firing resistor disposed at a bottom of the chamber. The fluid-ejection element includes a nozzle above the chamber through which the firing resistor is to eject the fluid from the chamber.

### BACKGROUND

Printing devices, including standalone printers as well as all-in-one (AlO) printing devices that combine printing functionality with other functionality like scanning and copying, can use a variety of different printing techniques. One type of printing technology is inkjet-printing technology, which is more generally a type of fluid-ejection technology. A fluid-ejection device, such as a printhead or a printing device having such a printhead, includes a number of fluid-ejection elements with respective nozzles. Firing a fluid-ejection element causes the element to eject fluid, such as a drop thereof, from its nozzle.

### BRIEF DESCRIPTION OF THE DRAWINGS

FIGS. 1A and 1B are a cross-sectional front-view and top-view diagrams, respectively, of an example fluid-ejection element of a fluid-ejection device in which fluid recirculation can occur through an above-chamber layer that is adjacent to a chamber layer and that includes a nozzle.

FIGS. 1C and 1D are cross-sectional top-view diagrams of different implementations of the example fluid-ejection element of FIGS. 1A and 1B.

FIGS. 2A and 2B are cross-sectional front-view diagrams of other example fluid-ejection elements of a fluid-ejection device in which fluid recirculation can occur through an above-chamber layer that is adjacent to a chamber layer and that includes a nozzle.

FIGS. 3A, 3B, and 3C are cross-sectional front-view diagrams of other example fluid-ejection elements of a fluid-ejection device in which fluid recirculation can occur through an above-chamber layer that is adjacent to a chamber layer and that does not include a nozzle.

FIGS. 4A and 4B are cross-sectional front-view diagrams of other example fluid-ejection elements of a fluid-ejection device in which fluid recirculation can occur through an above-chamber layer that is not adjacent to a chamber layer and that does not include a nozzle.

FIGS. 5 and 6 are top-view diagrams depicting different examples of how multiple fluid-ejection elements through which fluid recirculation can occur can be disposed relative to fluidic channels of a fluid-ejection device.

FIG. 7 is a block diagram of an example fluid-ejection element.

FIG. 8 is a block diagram of an example fluid-ejection device.

### DETAILED DESCRIPTION

As noted in the background, firing a fluid-ejection element of a fluid-ejection device causes the element to eject fluid from its nozzle. Different types of fluid-ejection devices, including different types of inkjet-printing devices, can employ a variety of different types of fluid. For example, inkjet-printing devices may use dye-based and/or pigmented inks. Dye-based inks include colorant that is fully dissolved in carrier liquid, whereas pigmented inks include a powder of solid colorant particles suspended in carrier liquid. Inks and other fluids vary in volatility, which is the propensity of the carrier liquid to evaporate, and further can vary in solid weight percentage, which is the percentage by weight of the solids contained within a fluid or an ink.

Fluids like ink that have greater volatility and/or that are higher in solid weight percentage are more likely to form viscous plugs at the nozzles of fluid-ejection elements. A viscous plug forms when fluid sufficiently dries out at the nozzle, leaving behind a greater mass of solid particles that clog the nozzle in the form of a plug. Such clogged nozzles can deleteriously affect image quality, by impeding or preventing fluid ejection through the nozzles, and/or by affecting the amount or trajectory of fluid ejected through the nozzles. Different fluid-ejection devices may be rated by “decap” time for different fluids, which is the length of time that nozzles can remain open and uncapped before plug formation is likely to occur.

To impede plug formation, some types of fluid-ejection elements permit fluid to be recirculated through their chambers even when the elements are in standby and not actively printing. The chamber of a fluid-ejection element is the cavity above the element's firing resistor that contains the volume of fluid that is ejected from the element when the resistor is energized, or fired. Traditionally the chamber of a fluid-ejection element was replenished with fluid after firing, after which this fluid remained within the chamber until the next time the element was fired. By comparison, more recent fluid-ejection element architectures can permit fluid to continuously recirculate through the chambers of fluid-ejection elements. Such fluid recirculation reduces the likelihood of plug formation.

However, due, for example, to the relationship between high print quality and high solid content and/or high volatility printing fluids, there is an ever-increasing desire to print with ever more challenging inks. That is, fluid-ejection devices are being called upon to eject fluid that have even greater volatility and/or that are even higher in solid weight percentage. Even fluid-ejection elements that provide for through-chamber fluid recirculation can struggle with such more challenging fluids. That is, even fluid-ejection elements that permit fluid to be recirculated through their chambers may still not satisfactorily inhibit plug formation with such fluids. A limited solution is to increase the velocity with which fluid is recirculated; however, such techniques are of limited effectiveness and may cause other image quality issues.

Described herein are techniques for fluid-ejection element fluid recirculation that can ameliorate these issues. Such techniques permit the usage of fluid with greater volatility and/or that are higher in solid weight percentage without having to increase recirculation velocity to impede plug formation as with existing fluid-ejection element architectures, broadening the types of ink, for instance, that can be used in inkjet-printing devices. For a type of fluid at a given volatility and a given solid weight percentage, the techniques can indeed allow for lower recirculation velocity while still impeding plug formation as compared to existing fluid-ejection element architectures, which may potentially improve resulting image quality.

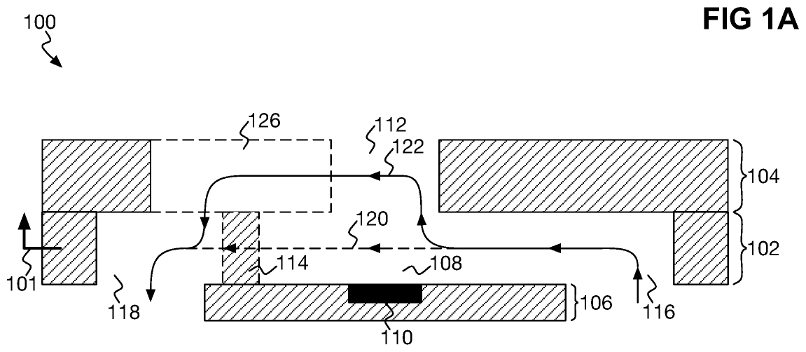

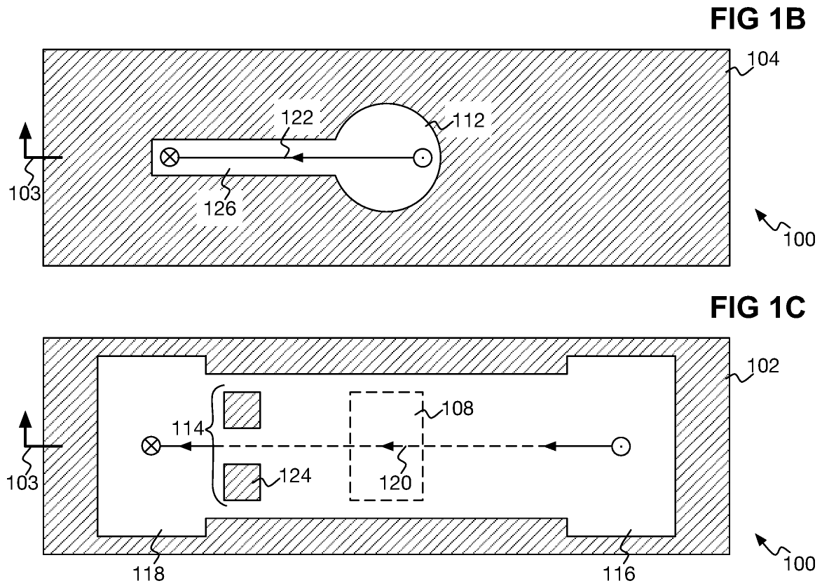

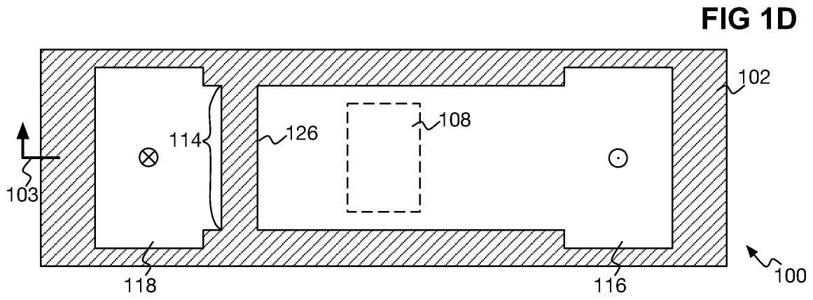

FIG. 1A shows a cross-sectional front view of an example fluid-ejection element 100 of a fluid-ejection device. The fluid-ejection element 100 can include a chamber layer 102, an above-chamber layer 104, and a substrate layer 106. The above-chamber layer 104 is adjacent and fluidically connected to the chamber layer 102 in the example of FIG. 1A.

The chamber layer 102 includes a chamber 108, a flow-directing structure 114, an inlet 116, and an outlet 118. The flow-directing structure 114 can be a pinch structure through which fluidic flow is reduced within the chamber layer 102, or an intra-layer wall through which fluidic flow cannot occur, as described later in the detailed description. The flow-directing structure 114 is located between the chamber 108 and the outlet 118.

In the example of FIG. 1A, the inlet 116 is fluidically connected within the chamber layer 102 to the chamber 108. If the flow-directing structure 114 is a pinch structure, then the outlet 118 is also fluidically connected within the chamber layer 102 to the chamber 108. However, if the flow-directing structure 114 is an intra-layer wall, then the outlet 118 is fluidically disconnected within the chamber layer 102 from chamber 108.

The fluid-ejection element 100 includes a firing resistor 110 disposed on the substrate layer 106 at the bottom of the chamber 108. Further, the above-chamber layer 104 includes or defines a nozzle 112 in the example of FIG. 1A, and also includes a channel 126. The nozzle 112 can be aligned (e.g., centered) over the chamber 108 and/or the firing resistor 110. Firing the firing resistor 110 causes ejection of fluid from the chamber 108 through the nozzle 112. The channel 126 is illustratively differentiated from the nozzle 112 in FIG. 1A by dotted lines.

Two fluid recirculation paths 120 and 122 are defined within the fluid-ejection element 100 in FIG. 1A, along which fluid can recirculate. The fluid recirculation path 120 is present if the flow-directing structure 114 is a pinch structure, and is absent if the structure 114 is an intra-chamber wall. The fluid recirculation path 122 is present regardless of whether the flow-directing structure 114 is a pinch structure or a wall. Therefore, even when the fluid-ejection element 100 is not printing, fresh fluid can continuously recirculate through the element 100.

A macrofluidic pump of the fluid-ejection device of which the fluid-ejection element 100 is a part may continuously pump fluid through the element 100 and the device's other fluid-ejection elements. In another implementation, the fluid-ejection element 100 may include a microfluidic pump at the bottom of the chamber layer 102 between the inlet 116 and the chamber 108, to continuously pump fluid through just the element 100. The microfluidic pump may be in addition to or in lieu of a macrofluidic pump of the fluid-ejection device as a whole.

Along the fluid recirculation path 120, if present, fluid recirculates through the chamber 108. Specifically, the recirculation path 120 is defined through the inlet 116 to the chamber layer 102, through or across the chamber 108 (and further through the flow-directing structure 114), and from the chamber layer 102 through the outlet 118. Fluid recirculates along the recirculation path 120 concurrent to recirculation along the recirculation path 122. Therefore, the recirculation path 120 may be referred to as a concurrent recirculation path.

Along the fluid recirculation path 122, fluid recirculates through the above-chamber layer 104. Specifically, the recirculation path 122 is defined through the inlet 116 to the chamber layer 102, from the chamber layer 102 to the above-chamber layer 104, through or across the above-chamber layer 104, from the above-chamber layer 104 to the chamber layer 102, and from the chamber layer 102 through the outlet 118. The flow-directing structure 114 directs flow from the chamber layer 102 to the above-chamber layer 104. The fluid recirculation paths 120 and 122 partially overlap at their beginnings and ends.

Fluid recirculation along the fluid recirculation path 120, if present, through the chamber 108 passes through the flow-directing structure 114. However, fluid recirculation along the fluid recirculation path 122 through the above-chamber layer 104 bypasses the flow-directing structure 114. That is, the above-chamber layer 104 is fluidically connected to the chamber layer 102 past the flow-directing structure 114, between the flow-directing structure 114 and the outlet 118.

Fluid recirculation through the above-chamber layer 104 in addition to or in lieu of the chamber 108 permits usage of fluid with greater volatility and/or that is higher in solid weight percentage without necessarily having to increase the velocity at which fluid is pumped through the fluid-ejection element 100. Similarly, having fluid recirculation through the above-chamber layer 104 in addition to or in lieu of the chamber 108 permits usage of fluid at a given volatility and a given solid weight percentage with lower recirculation velocity. This is because more of the recirculating fluid is concentrated near or at the nozzle 112 than if recirculation occurred just through the chamber 108.

The fluid recirculation along both the fluid recirculation paths 120 and 122 or along just the fluid recirculation path 122 has been described from right to left. However, in another implementation, fluid recirculation along both recirculation paths 120 and 122 or along just the recirculation path 122 may instead occur from left to right. In this case, the identified outlet 118 in FIG. 1A becomes the inlet and the identified inlet 116 in FIG. 1A becomes the outlet.

FIG. 1B shows a top view of the example fluid-ejection element 100 of FIG. 1A. The cross-sectional front view of FIG. 1A is the cross section at the line 103 of FIG. 1B. FIG. 1B specifically shows the above-chamber layer 104 of the element 100, including the nozzle 112 and the channel 122. The nozzle 112 of the fluid-ejection element 100 has a circular shape in the example of FIG. 1B. A portion of the fluid recirculation path 122 through the above-chamber layer 104 is depicted in FIG. 1B, upwards into the layer 104 per the arrow tip at the right of the nozzle 112 (viz., the circled dot), across the layer 104, and downwards from the layer 104 per the arrow tail at the left of the nozzle 112 (viz., the circled crosshatch).

FIGS. 1C and 1 D show a cross-sectional top view of different implementations of the example fluid-ejection element 100 of FIGS. 1A and 1B.

The cross-sectional front view of FIG. 1A is the cross section at the line 103 of FIGS. 1C and 1D, and the cross-sectional top view of FIGS. 1C and 1D is the cross section at the line 101 of FIG. 1A. FIGS. 1C and 1D specifically show the chamber layer 102 of the element 100. The chamber 108 is indicated by dashed lines for illustrative clarity. The firing resistor 110 below the chamber 108 is not depicted, also for illustrative clarity.

In the example of FIG. 1C, the flow-directing structure 114 is a pinch structure, such as posts 124, which reduce fluidic flow through the chamber layer 102 at the structure 114. The concurrent fluid recirculation path 120 through the chamber layer 102 is therefore present, and is depicted in FIG. 1C. Specifically, along the fluid recirculation path 120, fluid flows upwards through the inlet 116 per the arrow tip at the right, across the chamber 108, and downwards through the outlet 118 per the arrow tail at the left.

In the example of FIG. 1D, the flow-directing structure 114 is an intra-layer wall 126 that prevents fluidic flow through the chamber layer 102 at the structure 114. The concurrent fluid recirculation path 120 through the chamber layer 102 is therefore absent, and is not depicted in FIG. 1D. Fluid still flows upwards through the inlet 116 per the arrow tip at the right, and downwards through the outlet 118 per the arrow tail at the left, as part of the fluid recirculation path 122 of FIGS. 1A and 1B.

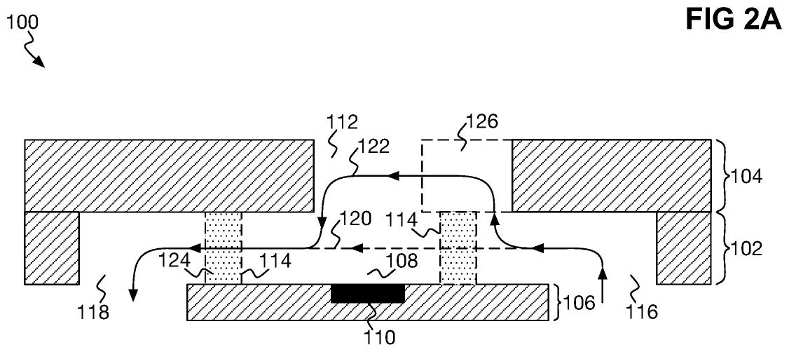

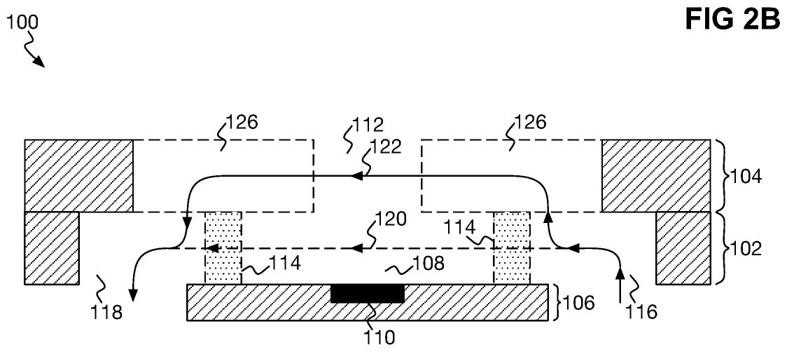

FIG. 2A shows a cross-sectional view of another example fluid-ejection element 100 of a fluid-ejection device. As in the cross-sectional front view of FIG. 1A, the fluid-ejection element 100 can include the chamber layer 102, the above-chamber layer 104, and the substrate layer 106 in FIG. 2A. Also as in FIG. 1A, the above-chamber layer 104 is adjacent and fluidically connected to the chamber layer 102 in FIG. 2A, and includes a nozzle 112 and a channel 126. The chamber layer 102 again includes the inlet 116, the outlet 118, and the chamber 108 at the bottom of which the firing resistor 110 is disposed. Firing of the resistor 110 causes ejection of fluid from the chamber 108 through the nozzle 112.

The chamber layer 102 in FIG. 2A may include a left flow-directing structure 114 between the outlet 118 and the chamber 108, as in FIG. 1A. The flow-directing structure 114 if present is a pinch structure including posts 124 and is not an intra-chamber wall in FIG. 2A. The outlet 118 is thus fluidically connected within the chamber layer 102 to the chamber 108. Unlike in FIG. 1A, the above-chamber layer 104 is fluidically connected to the chamber layer 102 before the left flow-directing structure 114 in FIG. 2A, between the flow-directing structure 114 and the chamber 108 Therefore, the fluid recirculation path 122 does not bypass the flow-directing structure 114 in FIG. 2A, unlike in FIG. 1A.

The chamber layer 102 in FIG. 2A includes a right flow-directing structure 114 between the inlet 116 and the chamber 108, which may be a pinch structure or an intra-chamber wall. The presence of the right-flow directing structure 114 ensures that fluid recirculates through the above-chamber layer 104 and thus along the fluid recirculation path 122. Without the right-flow directing structure 114, fluid may not recirculate along the recirculation path 122.

If the right flow-directing structure 114 is a pinch structure, then the inlet 116 is fluidically connected within the chamber layer 102 to the chamber 108. Therefore, fluid recirculates along the concurrent fluid recirculation path 120 through the chamber 108. In this case, fluid recirculates along both fluid recirculation paths 120 and 122.

If the right flow-directing structure 114 is an intra-chamber wall, then the inlet 116 is not fluidically connected within the chamber layer 102 to the chamber 108. In this case, the right flow-directing structure 114 fluidically disconnects the chamber 108 from the inlet 116 within the chamber layer 102, and thus prevents recirculation of fluid along the fluid recirculation path 120 through the chamber 108. Therefore, fluid circulates along just the fluid recirculation path 122.

If present, the fluid recirculation path 120 is defined in FIG. 2A as in

FIG. 1A. Specifically, as in FIG. 1A, the fluid recirculation path 120 is defined in FIG. 2A through the inlet 116 to the chamber layer 102, through or across the chamber 108, and from the chamber layer 102 through the outlet 118. In FIG. 2A, the fluid recirculation path 120 is further defined through the right flow-directing structure 114, and through the left flow-directing structure 114 if present.

The fluid recirculation path 122 is also defined in FIG. 2A as in FIG. 1A. Specifically, as in FIG. 1A, the recirculation path 122 is defined through the inlet 116 to the chamber layer 102, from the chamber layer 102 to the above-chamber layer 104, through or across the above-chamber layer 104, from the above-chamber layer 104 to the chamber layer 102, and from the chamber layer 102 through the outlet 118. In FIG. 2A, the fluid recirculation path 122 is further defined through the left flow-directing structure 114, if present.

The fluid recirculation along both the fluid recirculation paths 120 and 122 or along just the fluid recirculation path 122 has been described from right to left. However, in another implementation, fluid recirculation along both recirculation paths 120 and 122 or along just the recirculation path 122 may instead occur from left to right. In this case, the identified outlet 118 in FIG. 2A becomes the inlet and the identified inlet 116 in FIG. 2A becomes the outlet.

FIG. 2B shows a cross-sectional view of another example fluid-ejection element 100 of a fluid-ejection device. As in the cross-sectional front view of FIG. 1A, the fluid-ejection element 100 can include the chamber layer 102, the above-chamber layer 104, and the substrate layer 106 in FIG. 2B. Also as in FIG. 1A, the above-chamber layer 104 is adjacent and fluidically connected to the chamber layer 102 in FIG. 2B, and includes a nozzle 112 and a channel 126. The chamber layer 102 again includes the inlet 116, the outlet 118, and the chamber 108 at the bottom of which the firing resistor 110 is disposed. Firing of the resistor 110 causes ejection of fluid from the chamber 108 through the nozzle 112.

The chamber layer 102 in FIG. 2B includes a right flow-directing structure 114 between the inlet 116 and the chamber 108, a left flow-directing structure 114 between the outlet 118 and the chamber 108, or both the right and left structures 114. Each flow-directing structure 114 may be a pinch structure or an intra-chamber wall. The presence of one or both flow-directing structures 114 ensures that fluid recirculates within the above-chamber layer 104 and thus along the fluid recirculation path 122. In FIG. 2B, the fluid recirculation path 122 bypasses the left flow-directing structure 114 if present, because the above-chamber layer 104 is fluidically connected to the chamber layer 102 after the left flow-directing structure 114.

If just the right or left flow-directing structure 114 is present and is a pinch structure, or if both the right and left structures 114 are present and are pinch structures, then fluid also recirculates along the concurrent fluid recirculation path 120 through the chamber 108. In this case, fluid recirculates along both the fluid recirculation paths 120 and 122. However, if any present flow-directing structure 114 is a wall structure, then fluid does not recirculate along the concurrent fluid recirculation path 120 through the chamber 108. In this case, fluid recirculates along just the fluid recirculation path 122.

If present, the fluid recirculation path 120 is defined in FIG. 2B as in FIG. 1A. Specifically, as in FIG. 1A, the recirculation path 120 is defined in FIG. 2B through the inlet 116 to the chamber layer 102, through or across the chamber 108, and from the chamber layer 102 through the outlet 118.

In FIG. 2B, the recirculation path 120 is further defined through the right flow-directing structure 114 if present, and through the left flow-directing structure 114 if present.

The fluid recirculation path 122 is also defined in FIG. 2B as in FIG. 1A. Specifically, as in FIG. 1A, the recirculation path 122 is defined through the inlet 116 to the chamber layer 102, from the chamber layer 102 to the above-chamber layer 104, through or across the above-chamber layer 104, from the above-chamber layer 104 to the chamber layer 102, and from the chamber layer 102 through the outlet 118.

The fluid recirculation along both the fluid recirculation paths 120 and 122 or along just the fluid recirculation path 122 has been described from right to left. However, in another implementation, fluid recirculation along both recirculation paths 120 and 122 or along just the recirculation path 122 may instead occur from left to right. In this case, the identified outlet 118 in FIG. 2B becomes the inlet and the identified inlet 116 in FIG. 2B becomes the outlet.

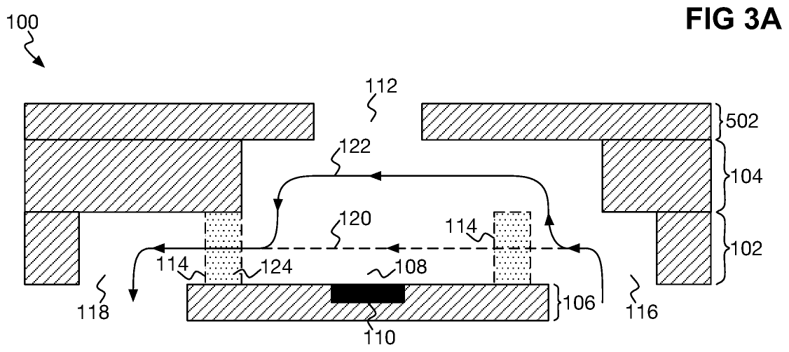

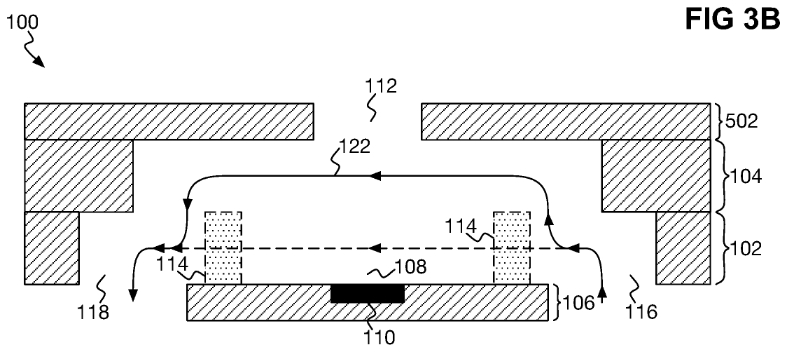

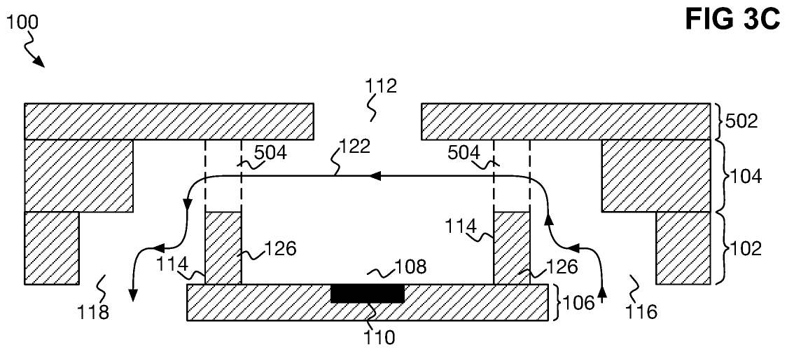

FIG. 3A shows a cross-sectional view of another fluid-ejection element 100 of a fluid-ejection device. As in the cross-sectional view of FIG. 1A, the fluid-ejection element 100 can include the chamber layer 102, the above-chamber layer 104, and the substrate layer 106. Also as in FIG. 1A, the above-chamber layer 104 is adjacent and fluidically connected to the chamber layer 104 in FIG. 3A. The chamber layer 102 again includes the inlet 116, the outlet 118, and the chamber 108 at the bottom of which the firing resistor 110 is disposed.

Firing of the resistor 110 causes ejection of fluid from the chamber 108 through the nozzle 112.

Unlike in FIG. 1A, the fluid-ejection element 100 in FIG. 3A includes a tophat layer 502 adjacent and fluidically connected to the above-chamber layer 104. The nozzle 112 is disposed at the tophat layer 502 in FIG. 3A, instead of at the above-chamber layer 104. Fluid may not recirculate through the tophat layer 502, however. Inclusion of the tophat layer 502 in addition to the above-chamber layer 104 in FIG. 3A can permit the nozzle 112 to be sized independently of the desired fluid recirculation through the above-chamber layer 104. By comparison, disposal of the nozzle 112 at the above-chamber layer 104 may constrain how narrow the nozzle 112 can be while still accommodating fluid recirculation through the layer 104.

The chamber layer 102 in FIG. 3A may include a left flow-directing structure 114 between the outlet 118 and the chamber 108, and which if present is a pinch structure including posts 124 and is not an intra-chamber wall, as in FIG. 2A. The outlet 118 is thus fluidically connected within the chamber layer 102 to the chamber 108. The above-chamber layer 104 is fluidically connected to the chamber layer 102 before the left flow-directing structure 114 in FIG. 3A, between the flow-directing structure 114 and the chamber 108. Therefore, the fluid recirculation path 122 does not bypass the flow-directing structure 114 in FIG. 3A, as in FIG. 2A.

Also as in FIG. 2A, the chamber layer 102 in FIG. 3A includes a right flow-directing structure 114 between the inlet 116 and the chamber 108, which may be a pinch structure or an intra-chamber wall. If the right flow-directing structure 114 is a pinch structure, then the inlet 116 is fluidically connected within the chamber layer 102 to the chamber 108. Therefore, fluid recirculates along the concurrent recirculation path 120 through the chamber 108. In this case, fluid recirculates along both fluid recirculation paths 120 and 122.

If the right flow-directing structure 114 is an intra-chamber wall, then the inlet 116 is not fluidically connected within the chamber layer 102 to the chamber 108. In this case, the right flow-directing structure 114 fluidically disconnects the chamber 108 from the inlet 116 within the chamber layer 102, and thus prevents recirculation of fluid along the fluid recirculation path 120 through the chamber 108. Therefore, fluid circulates along just the fluid recirculation path 122.

If present, the fluid recirculation path 120 is defined in FIG. 3A as in FIG. 1A. Specifically, as in FIG. 1A, the fluid recirculation path 120 is defined in FIG. 3A through the inlet 116 to the chamber layer 102, through or across the chamber 108, and from the chamber layer 102 through the outlet 118. In FIG. 3A, the fluid recirculation path 120 is further defined through the right flow-directing structure 114, and through the left flow-directing structure 114 if present.

The fluid recirculation path 122 is also defined in FIG. 3A as in FIG. 1A. Specifically, as in FIG. 1A, the recirculation path 122 is defined through the inlet 116 to the chamber layer 102, from the chamber layer 102 to the above-chamber layer 104, through or across the above-chamber layer 104, from the above-chamber layer 104 to the chamber layer 102, and from the chamber layer 102 through the outlet 118. In FIG. 3A, the fluid recirculation path 122 is further defined through the left flow-directing structure 114 if present.

The fluid recirculation along both the fluid recirculation paths 120 and 122 or along just the fluid recirculation path 122 has been described from right to left. However, in another implementation, fluid recirculation along both recirculation paths 120 and 122 or along just the recirculation path 122 may instead occur from left to right. In this case, the identified outlet 118 in FIG. 3A becomes the inlet and the identified inlet 116 in FIG. 3A becomes the outlet.

FIG. 3B shows a cross-sectional view of another example fluid-ejection element 100 of a fluid-ejection device. As in the cross-sectional front view of FIG. 3A, the fluid-ejection element 100 can include the chamber layer 102, the above-chamber layer 104, the substrate layer 106, and the tophat layer 502 in FIG. 3B. The above-chamber layer 104 is adjacent and fluidically connected to the chamber layer 102, which again includes the inlet 116, the outlet 118, and the chamber 108 at the bottom of which the firing resistor 110 is disposed. Firing of the resistor 110 causes ejection of fluid from the chamber 108 through the nozzle 112 disposed at the tophat layer 502, which is adjacent and fluidically connected to the above-chamber layer 104.

The chamber layer 102 in FIG. 3B includes a right flow-directing structure 114 between the inlet 116 and the chamber 108, a left flow-directing structure 114 between the outlet 118 and the chamber 108, or both the right and left structures 114, as in FIG. 2B. Each flow-directing structure 114 may be a pinch structure or an intra-chamber wall. The fluid recirculation path 122 bypasses the left flow-directing structure 114 if present, because the above-chamber layer 104 is fluidically connected to the chamber layer 102 after the left flow-directing structure 114.

As in FIG. 2B, if just the right or left flow-directing structure 114 is present and is a pinch structure, or if both the right and left structures 114 are present and are pinch structures, then fluid also recirculates along the concurrent fluid recirculation path 120 through the chamber 108 in FIG. 3B. In this case, fluid recirculates along both fluid recirculation paths 120 and 122. However, if any present flow-directing structure 114 is a wall structure, then fluid does not recirculate along the concurrent fluid recirculation path 120 through the chamber 108. In this case, fluid recirculates along just the fluid recirculation path 122.

If present, the fluid recirculation path 120 is defined in FIG. 3B as in FIG. 1A. Specifically, as in FIG. 1A, the recirculation path 120 is defined in FIG. 3B through the inlet 116 to the chamber layer 102, through or across the chamber 108, and from the chamber layer 102 through the outlet 118. In FIG. 3B, the recirculation path 120 is further defined through the right flow-directing structure 114 if present, and through the left flow-directing structure 114 if present, as in FIG. 2B.

The fluid recirculation path 122 is also defined in FIG. 3B as in FIG. 1A. Specifically, as in FIG. 1A, the recirculation path 122 is defined through the inlet 116 to the chamber layer 102, from the chamber layer 102 to the above-chamber layer 104, through or across the above-chamber layer 104, from the above-chamber layer 104 to the chamber layer 102, and from the chamber layer 102 through the outlet 118.

The fluid recirculation along both the fluid recirculation paths 120 and 122 or along just the fluid recirculation path 122 has been described from right to left. However, in another implementation, fluid recirculation along both recirculation paths 120 and 122 or along just the recirculation path 122 may instead occur from left to right. In this case, the identified outlet 118 in FIG. 3B becomes the inlet and the identified inlet 116 in FIG. 3B becomes the outlet.

FIG. 3C shows a cross-sectional view of another example fluid-ejection element 100 of a fluid-ejection device. As in the cross-sectional front view of FIG. 3A, the fluid-ejection element 100 can include the chamber layer 102, the above-chamber layer 104, the substrate layer 106, and the tophat layer 502 in FIG. 3C. The above-chamber layer 104 is adjacent and fluidically connected to the chamber layer 102, which again includes the inlet 116, the outlet 118, and the chamber 108 at the bottom of which the firing resistor 110 is disposed. Firing of the resistor 110 causes ejection of fluid from the chamber 108 through the nozzle 112 disposed at the tophat layer 502, which is adjacent and fluidically connected to the above-chamber layer 104.

The chamber layer 102 in FIG. 3C includes both the right and left flow-directing structures 114. Each flow-directing structure 114 is specifically an intra-chamber wall 126 in FIG. 3C. Fluid recirculates along just the fluid recirculation path 122 in FIG. 3C (and not the fluid recirculation path 120 of the prior figures), because the flow-directing structures 114 are intra-chamber walls 126. The fluid recirculation path 122 bypasses the left flow-directing structure 114, because the above-chamber layer 104 is fluidically connected to the chamber layer 102 after the left flow-directing structure 114.

In the example of FIG. 3C, the above-chamber layer 104 includes a right pinch structure 504, a left pinch structure 504, or both left and right pinch structures 504. Each pinch structure 504 may be aligned over a respective flow-directing structure 114 within the chamber layer 102, as shown in FIG. 3C. The pinch structures 504 reduce the flow of fluid through the above-chamber layer 104 along the fluid-recirculation path 122.

The fluid recirculation path 122 is defined in FIG. 3C as in FIG. 1A. Specifically, as in FIG. 1A, the recirculation path 122 is defined through the inlet 116 to the chamber layer 102, from the chamber layer 102 to the above-chamber layer 104, through or across the above-chamber layer 104, from the above-chamber layer 104 to the chamber layer 102, and from the chamber layer 102 through the outlet 118. The fluid recirculation path 122 is also defined through the right pinch structure 504 if present and through the left pinch structure 504 if present.

The fluid recirculation along the fluid recirculation path 122 has been described from right to left. However, in another implementation, fluid recirculation along the recirculation path 122 may instead occur from left to right. In this case, the identified outlet 118 in FIG. 3B becomes the inlet and the identified inlet 116 in FIG. 3B becomes the outlet.

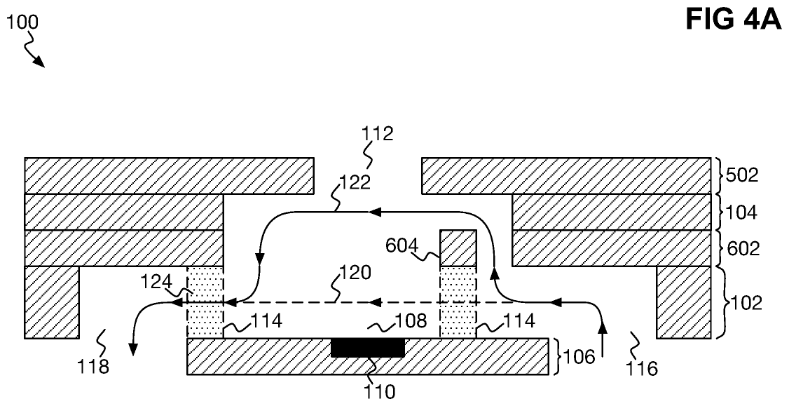

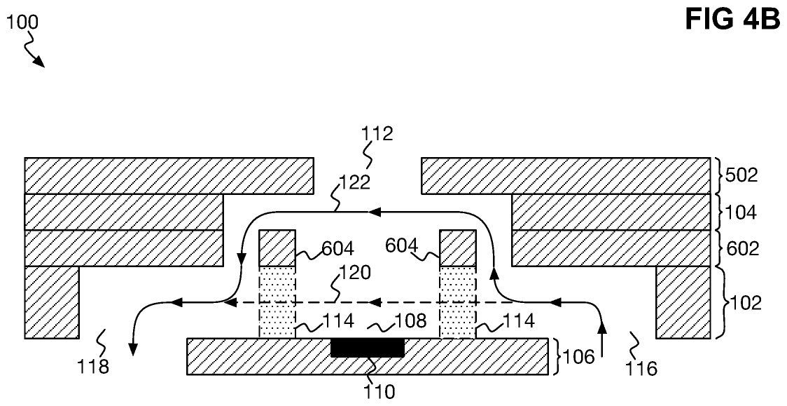

FIG. 4A shows a cross-sectional view of another fluid-ejection element 100 of a fluid-ejection device. As in the cross-sectional view of FIG. 3A, the fluid-ejection element 100 can include the chamber layer 102, the above-chamber layer 104, the substrate layer 106, and the tophat layer 502 in FIG. 4A. The chamber layer 102 again includes the inlet 116, the outlet 118, and the chamber 108 at the bottom of which the firing resistor 110 is disposed. Firing of the resistor 110 causes ejection of fluid from the chamber 108 through the nozzle 112 disposed at the tophat layer 502, which is adjacent and fluidically connected to the above-chamber layer 104. If the tophat layer 502 is absent, then the nozzle is disposed at the above-chamber layer 104 instead.

In FIG. 4A, the fluid-ejection element 100 includes another above-chamber layer 602, in addition to the above-chamber layer 104. The above-chamber layer 104 may be considered a top above-chamber layer, and the above-chamber layer 602 may be considered a bottom above-chamber layer. The above-chamber layer 602 is adjacent and fluidically connected to the chamber layer 102 and the above-chamber layer 104. Unlike in FIG. 1A, therefore, the above-chamber layer 104 is not adjacent to the chamber layer 102 in FIG. 4A. The height of each above-chamber layer 104 and 602 may be identical, and the total height of both layers 104 and 602 may be equal to the height of the above-chamber layer 104 alone in FIG. 1A.

The above-chamber layer 602 includes an intra-layer wall 604, over and between the chamber 108 and the inlet 116 of the chamber layer 102. The intra-layer wall 604 prevents recirculation of fluid through the above-chamber layer 602. That is, of the two above-chamber layers 104 and 602, fluid recirculates just through the layer 104.

The chamber layer 102 in FIG. 4A may include a left flow-directing structure 114 between the outlet 118 and the chamber 108, and which if present is a pinch structure including posts 124 and is not an intra-chamber wall, as in

FIG. 2A. The outlet 118 is thus fluidically connected within the chamber layer 102 to the chamber 108. The above-chamber layer 104 is, through the above-chamber layer 602, fluidically connected to the chamber layer 102 before the left flow-directing structure 114 in FIG. 4A, between the flow-directing structure 114 and the chamber 108. Therefore, the fluid recirculation path 122 does not bypass the flow-directing structure 114 in FIG. 4A, as in FIG. 3A.

Also as in FIG. 2A, the chamber layer 102 in FIG. 3A includes a right flow-directing structure 114 between the inlet 116 and the chamber 108, which may be a pinch structure or an intra-chamber wall. If the right flow-directing structure 114 is a pinch structure, then the inlet 116 is fluidically connected within the chamber layer 102 to the chamber 108. Therefore, fluid recirculates along the concurrent recirculation path 120 through the chamber 108. In this case, fluid recirculates along both fluid recirculation paths 120 and 122.

If the right flow-directing structure 114 is an intra-chamber wall, then the inlet 116 is not fluidically connected within the chamber layer 102 to the chamber 108. In this case, the right flow-directing structure 114 fluidically disconnects the chamber 108 from the inlet 116 within the chamber layer 102, and thus prevents recirculation of fluid along the fluid recirculation path 120 through the chamber 108. Therefore, fluid circulates along just the fluid recirculation path 122.

If present, the fluid recirculation path 120 is defined in FIG. 4A as in FIG. 1A. Specifically, as in FIG. 1A, the fluid recirculation path 120 is defined in FIG. 4A through the inlet 116 to the chamber layer 102, through or across the chamber 108, and from the chamber layer 102 through the outlet 118. In FIG. 4A, the fluid recirculation path 120 is further defined through the right flow-directing structure 114, and through the left flow-directing structure 114 if present.

The fluid recirculation path 122 is also defined in FIG. 4A as in FIG. 1A. Specifically, as in FIG. 1A, the recirculation path 122 is defined through the inlet 116 to the chamber layer 102, from the chamber layer 102 to the above-chamber layer 104, through or across the above-chamber layer 104, from the above-chamber layer 104 to the chamber layer 102, and from the chamber layer 102 through the outlet 118. In FIG. 4A, the fluid recirculation path 122 is further defined through the above-chamber layer 602 (both from and to the above-chamber layer 104), and through the left flow-directing structure 114 if present.

The fluid recirculation along both the fluid recirculation paths 120 and 122 or along just the fluid recirculation path 122 has been described from right to left. However, in another implementation, fluid recirculation along both recirculation paths 120 and 122 or along just the recirculation path 122 may instead occur from left to right. In this case, the identified outlet 118 in FIG. 4A becomes the inlet and the identified inlet 116 in FIG. 4A becomes the outlet.

FIG. 4B shows a cross-sectional view of another example fluid-ejection element 100 of a fluid-ejection device. As in the cross-sectional front view of FIG. 4A, the fluid-ejection element 100 can include the chamber layer 102, the above-chamber layers 602 and 104, the substrate layer 106, and the tophat layer 502 in FIG. 4B. The chamber layer 102 again includes the inlet 116, the outlet 118, and the chamber 108 at the bottom of which the firing resistor 110 is disposed. Firing of the resistor 110 causes ejection of fluid from the chamber 108 through the nozzle 112 disposed at the tophat layer 502, which is adjacent and fluidically connected to the above-chamber layer 104. If the tophat layer 502 is absent, then the nozzle is disposed at the above-chamber layer 104 instead.

The chamber layer 102 in FIG. 4B includes a right flow-directing structure 114 between the inlet 116 and the chamber 108, a left flow-directing structure 114 between the outlet 118 and the chamber 108, or both the right and left structures 114, as in FIG. 2B. Each flow-directing structure 114 may be a pinch structure or an intra-chamber wall. The fluid recirculation path 122 bypasses the left flow-directing structure 114 if present, because the above-chamber layer 104 is fluidically connected to the chamber layer 102 after the left flow-directing structure 114.

If just the right flow-directing structure 114 is present, then the above-chamber layer 602 includes a right intra-layer wall 604, over and between the chamber 108 and the inlet 116 of the chamber layer 102. If just the left flow-directing structure 114 is present, then the above-chamber layer 602 includes a left intra-layer wall 604, over and between the chamber 108 and the inlet 116 of the chamber layer 102. If both flow-directing structures 114 are present, then the above-chamber layer 602 includes just the left intra-layer wall 604, just the right intra-layer wall 604, or both intra-layer walls 604. The intra-layer walls 604 prevent recirculation of fluid through the above-chamber layer 602. Fluid recirculates just through the above-chamber layer 104.

As in FIG. 2B, if just the right or left flow-directing structure 114 is present and is a pinch structure, or if both the right and left structures 114 are present and are pinch structures, then fluid also recirculates along the concurrent fluid recirculation path 120 through the chamber 108 in FIG. 4B. In this case, fluid recirculates along both fluid recirculation paths 120 and 122. However, if any present flow-directing structure 114 is a wall structure, then fluid does not recirculate along the concurrent fluid recirculation path 120 through the chamber 108. In this case, fluid recirculates along just the fluid recirculation path 122.

If present, the fluid recirculation path 120 is defined in FIG. 4B as in FIG. 1A. Specifically, as in FIG. 1A, the recirculation path 120 is defined in FIG. 34 through the inlet 116 to the chamber layer 102, through or across the chamber 108, and from the chamber layer 102 through the outlet 118. In FIG. 4B, the recirculation path 120 is further defined through the right flow-directing structure 114 if present, and through the left flow-directing structure 114 if present, as in FIG. 2B.

The fluid recirculation path 122 is also defined in FIG. 4B as in FIG. 1A. Specifically, as in FIG. 1A, the recirculation path 122 is defined through the inlet 116 to the chamber layer 102, from the chamber layer 102 to the above-chamber layer 104, through or across the above-chamber layer 104, from the above-chamber layer 104 to the chamber layer 102, and from the chamber layer 102 through the outlet 118. The fluid recirculation path 122 is further defined in FIG. 4B through the above-chamber layer 602 (both from and to the above-chamber layer 104).

The fluid recirculation along both the fluid recirculation paths 120 and 122 or along just the fluid recirculation path 122 has been described from right to left. However, in another implementation, fluid recirculation along both recirculation paths 120 and 122 or along just the recirculation path 122 may instead occur from left to right. In this case, the identified outlet 118 in FIG. 4B becomes the inlet and the identified inlet 116 in FIG. 4B becomes the outlet.

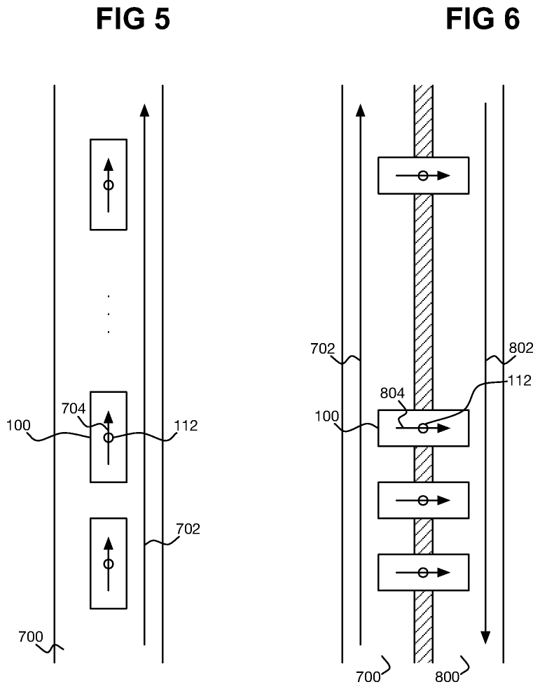

FIG. 5 shows a top view of an example fluidic channel 700 of a fluid-ejection device. Fluid is pumped within the channel 700 along a fluid path 702. In the example of FIG. 5, multiple fluid-ejection elements 100 are disposed length-wise over the channel 700. The fluid-ejection elements 100 have respective nozzles 112. The fluid-ejection elements 100 are fluidically connected to the channel 700. Fluid thus flows within each fluid-ejection element 100 along a fluid-recirculation path 704 past the respective nozzle 112 of the element 100 and parallel to the fluid path 702.

FIG. 6 shows a top view of an example pair of fluidic channels 700 and 800 of a fluid-ejection device. Fluid is pumped within the channel 700 along the fluid path 702, as in FIG. 5, and then returns within the channel 800 along the fluid path 802. The channels 700 and 800 are thus fluidically connected at some point in the fluid-ejection device, which is not depicted in FIG. 6. The fluid-ejection elements 100 are disposed perpendicular to and span the channels 700 and 800. The fluid-ejection elements 100 are fluidically connected to both channels 700 and 800. Fluid thus flows within each fluid-ejection element 100 along a fluid-recirculation path 804 past the respective nozzle 112 of the element 100, perpendicular to the fluid paths 702 and 802.

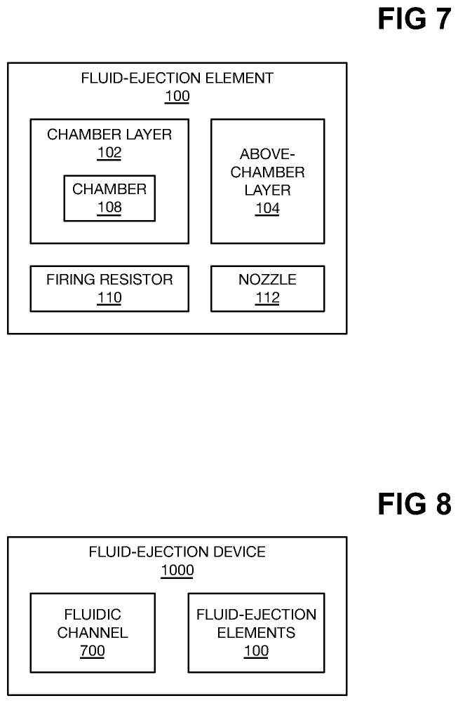

FIG. 7 shows an example fluid-ejection element 100 of a fluid-ejection device. The fluid-ejection element 100 includes a chamber layer 102 having a chamber 108. The fluid-ejection element 100 includes an above-chamber layer 104 fluidically connected to the chamber layer 102 and through which fluid is to recirculate. The fluid-ejection element 100 includes a firing resistor 110 disposed at a bottom of the chamber 108. The fluid-ejection element 100 includes a nozzle 112 above the chamber 108 through which the firing resistor 110 is to eject the fluid from the chamber 108.

FIG. 8 shows an example fluid-ejection device 1000. The fluid-ejection device 1000 may be a fluid-ejection printhead, or a printing device that includes such a printhead. The fluid-ejection device 1000 includes a fluidic channel 700. The fluid-ejection device 1000 includes fluid-ejection elements 100 fluidically connected to the fluidic channel 700. Each fluid-ejection element 100 can include a chamber layer having a chamber from which fluid is ejectable, and an above-chamber layer fluidically connected to the chamber layer and through which the fluid is to recirculate.

Techniques have been described herein that provide for fluid-jet element recirculation of fluid having greater volatility and/or that is higher in solid weight percentage, without having to increase recirculation velocity to impede plug formation. For fluid at a given volatility and a given solid weight percentage, the techniques can permit fluid recirculation at a lower velocity while still impeding plug formation. Fluid recirculation occurs within a fluid-jet element at an above-chamber layer of the element.

We claim:

1. A fluid-ejection element of a fluid-ejection device comprising:
a chamber layer having a chamber;
an above-chamber layer fluidically connected to the chamber layer and through which fluid is to recirculate;
a firing resistor disposed at a bottom of the chamber; and
a nozzle above the chamber through which the firing resistor is to eject the fluid from the chamber.

2. The fluid-ejection element of claim 1, wherein the above-chamber layer through which the fluid is to recirculate is adjacent to the chamber layer and comprises the nozzle.

3. The fluid-ejection element of claim 1, further comprising a tophat layer above and fluidically connected to the above-chamber layer, the tophat layer comprising the nozzle,
wherein the above-chamber layer through which the fluid is to recirculate is adjacent to the chamber layer and the tophat layer.

4. The fluid-ejection element of claim 1, wherein the above-chamber layer is a top above-chamber layer through which the fluid is to recirculate, the fluid-ejection element further comprising:
a bottom above-chamber layer adjacent and fluidically connected to both the chamber layer and the top above-chamber layer,
wherein the bottom above-chamber layer comprises an intra-layer wall preventing recirculation of the fluid through the bottom above-chamber layer.

5. The fluid-ejection element of claim 1, wherein the chamber layer comprises:
an inlet;
an outlet; and
an intra-layer wall fluidically disconnecting the chamber from the inlet or the outlet within the chamber layer,
wherein a fluid recirculation path is defined through the inlet to the chamber layer, from the chamber layer to the above-chamber layer, through the above-chamber layer, from the above-chamber layer to the chamber layer, and from the chamber layer through the outlet,
and wherein no concurrent fluid recirculation path is defined through the chamber.

6. The fluid-ejection element of claim 1, wherein the chamber layer comprises:
an inlet fluidically connected within the chamber layer to the chamber; and
an outlet fluidically connected within the chamber layer to the chamber,
wherein a fluid recirculation path is defined through the inlet to the chamber layer, from the chamber layer to the above-chamber layer, through the above-chamber layer, from the above-chamber layer to the chamber layer, and from the chamber layer through the outlet,
and wherein a concurrent fluid recirculation path is defined through the inlet to the chamber layer, through the chamber, and from the chamber layer through the outlet.

7. The fluid-ejection element of claim 1, wherein the chamber layer comprises:
an outlet fluidically connected within the chamber layer to the chamber,
a flow-directing structure between the chamber and the outlet to direct fluid from the chamber layer to the above-chamber layer,
and wherein the above-chamber layer is fluidically connected to the chamber layer past the flow-reducing structure to permit the fluid to bypass the flow-reducing structure during recirculation through the above-chamber layer.

8. The fluid-ejection element of claim 7, wherein the flow-directing structure comprises a pinch structure or an intra-layer wall.

9. A fluid-ejection device comprising:
a fluidic channel; and
a plurality of fluid-ejection elements fluidically connected to the fluidic channel, each fluid-ejection element comprising a chamber layer having a chamber from which fluid is ejectable, and an above-chamber layer fluidically connected to the chamber layer and through which the fluid is to recirculate.

10. The fluid-ejection device of claim 9, wherein the chamber layer of each fluid-ejection element comprises:
an inlet; and
an outlet,
wherein the above-chamber layer of each fluid-ejection element through which the fluid is to recirculate is adjacent to the chamber layer and comprises a nozzle through which the fluid is ejected from the chamber,
and wherein for each fluid-ejection element a fluid recirculation path is defined through the inlet to the chamber layer, from the chamber layer to the above-chamber layer, through the above-chamber layer, from the above-chamber layer to the chamber layer, and from the chamber layer through the outlet.

11. The fluid-ejection device of claim 10, wherein the chamber layer of each fluid-ejection element further comprises an intra-layer wall fluidically disconnecting the chamber from the inlet or the outlet within the chamber layer to prevent fluid recirculation through the chamber.

12. The fluid-ejection device of claim 9, wherein the chamber layer of each fluid-ejection element comprises:
an inlet; and
an outlet,
wherein each fluid-ejection element further comprises a tophat layer above and fluidically connected to the above-chamber layer, the tophat layer comprising a nozzle through which the fluid is ejected from the chamber,
wherein the above-chamber layer of each fluid-ejection element through which the fluid is to recirculate is adjacent to the chamber layer and the tophat layer,
and wherein for each fluid-ejection element a fluid recirculation path is defined through the inlet to the chamber layer, from the chamber layer to the above-chamber layer, through the above-chamber layer, from the above-chamber layer to the chamber layer, and from the chamber layer through the outlet.

13. The fluid-ejection device of claim 12, wherein the chamber layer of each fluid-ejection element further comprises an intra-layer wall fluidically disconnecting the chamber from the inlet or the outlet within the chamber layer to prevent fluid recirculation through the chamber.

14. The fluid-ejection device of claim 9, wherein the chamber layer of each fluid-ejection element comprises:
an inlet; and
an outlet,
wherein the above-chamber layer of each fluid-ejection element is a top above-chamber layer through which the fluid is to recirculate, and each fluid-ejection element further comprises:
a bottom above-chamber layer adjacent and fluidically connected to both the chamber layer and the top above-chamber layer,
wherein the bottom above-chamber layer of each fluid-ejection element comprises an intra-layer wall preventing recirculation of the fluid through the bottom above-chamber layer,
and wherein for each fluid-ejection element a fluid recirculation path is defined through the inlet to the chamber layer, from the chamber layer through the bottom above-chamber layer to the top above-chamber layer, through the top above-chamber layer, from the top above-chamber layer through the bottom above-chamber layer to the chamber layer, and from the chamber layer through the outlet.

15. The fluid-ejection device of claim 14, wherein the chamber layer of each fluid-ejection element further comprises an intra-layer wall fluidically disconnecting the chamber from the inlet or the outlet within the chamber layer to prevent fluid recirculation through the chamber.
